(19) United States
(12) Patent Application Publication
(10) Pub. No.: US 2020/0036064 A1
(43) Pub. Date: Jan. 30, 2020

(54) BATTERY MODULE HEATER

(71) Applicant: BAE Systems Controls Inc., Endicott, NY (US)

(72) Inventors: Robert A. Hess, Seneca Falls, NY (US); Brad J. Mulcahy, Castle Creek, NY (US)

(73) Assignee: BAE Systems Controls Inc., Endicott, NY (US)

(21) Appl. No.: 16/043,330

(22) Filed: Jul. 24, 2018

(51) Int. Cl. H01M 10/615; H01M 10/625; H01M 10/617; H01M 10/6571; H01M 10/63

(52) U.S. Cl. CPC H01M 10/615; H01M 10/625; H01M 10/617; B60K 2001/008; H01M 10/63; H01M 2220/20; H01M 10/6571

(57) ABSTRACT

A battery module heating assembly for a battery module having a plurality of battery cells arranged in a frame with the cell terminals being connected to one another via busbars. The busbars are covered by the heating assembly. The heating assembly includes at least one thermally conductive pad in contact with one or more heat spreader plates. The heat spreader plates have heating elements attached thereto.

### FIELD OF DISCLOSURE

The present disclosure relates to battery heaters and more particularly to a device for heating a battery module of a hybrid electric or an electric vehicle.

### BACKGROUND

A battery module for use in a hybrid electric vehicle (HEV) and an electric vehicle (EV) is an assembly of individual battery cells arranged in a lattice configuration and connected in series and parallel to achieve a specific module voltage and power level. For those situations where the battery module needs to operate at cold temperatures, heaters have been used to warm the battery module to improve performance. As defined herein, vehicle refers to any mobile item such as cars, trucks, buses, aircraft, drones, ships, ferries and similar items.

In one approach, battery modules are heated by circulating warming air around the cells. The cells are held within a frame structure which is of such construction to allow warm air to flow around the cells. Heating occurs primarily through the sides of the cell cans. In some designs, tubes containing a fluid are routed through the gaps in the cell lattice. Warm fluid is circulated in the tube, thereby heating the cell. Here again, the primary mode of heating is through the cell can. In another approach, the module may have heaters affixed to its sides and heating occurs through the structure of the frame which holds the cells.

For select applications, it may not be practical to use the can of the cell as a primary heating path. For example, the design of the frame which holds the cell may need to be structurally robust and have no gaps. In other situations, the arrangement of the cell in the lattice is so dense as to preclude spacing for airflow or heating tubes. A number of approaches run heating coils across the positive and negative terminals of the battery. In one example the heating coils are routed over each terminal where differing power is applied to the different coils to achieve uniform heating over time. In another example, the heating coil is affixed to a rigid/semi-rigid circuit board allowing the cells to be electrical connected in groups.

### BRIEF SUMMARY

In one embodiment, a battery module is disclosed having a plurality of battery cells arranged in a frame with the cell terminals being connected to one another via busbars. The busbars are covered by a heating assembly. The heating assembly includes at least one thermally conductive pad in contact with one or more heat spreader plates. The heat spreader plates have heating elements attached thereto.

In one embodiment, multiple modules are assembled into a battery pack, each module having its own heating assembly. In one example, multiple modules are assembled into a battery pack; wherein the modules are placed adjacent to one another and share a heating assembly between the modules.

### BRIEF DESCRIPTION OF THE DRAWINGS

The details of the present disclosure, both as to its structure and operation, can be understood by referring to the accompanying drawings, in which like reference numbers and designations refer to like elements.

FIG. 1 is an exploded isometric view of a battery module and heating assembly according to one embodiment of the present disclosure.

FIG. 2 is an isometric view of an assembled battery module and heating assembly according to one embodiment of the present disclosure.

FIG. 3 is a side elevation schematic view of a battery module and heating assembly according to one embodiment of the present disclosure.

FIG. 4 is a top schematic view of a battery module and heating assembly according to one embodiment of the present disclosure.

### DETAILED DESCRIPTION

In one embodiment, an assembly for heating a battery module is disclosed. The battery module is composed of a plurality of battery cells assembled as a single module. In one embodiment the cells are cylindrically shaped. The cells are typically arranged in a lattice. Individual rows of the lattice typically have the cells oriented in one direction. These cells represent a cell group. The cells in the cell group are typically electrically connected together in parallel. The cells in adjacent rows are oriented opposite from one another. These rows are then connected in series to achieve the requisite voltage level.

One typical use of such a battery module is in an HEV and EV in which a plurality of battery modules are assembled into a battery pack. The cells in each module are arranged in a frame and are connected together via the busbars. The busbars are typically constructed of thin metal plates directly welded to the cell terminals. The welding operation helps to provide structural rigidity.

The arrangement of the module allows for direct heating of each cell using conduction through the cell anodes and cathodes. Recognizing that the busbars are thermally conductive, in one embodiment, heating assembly of the present disclosure uses the busbars as a path for cell heating.

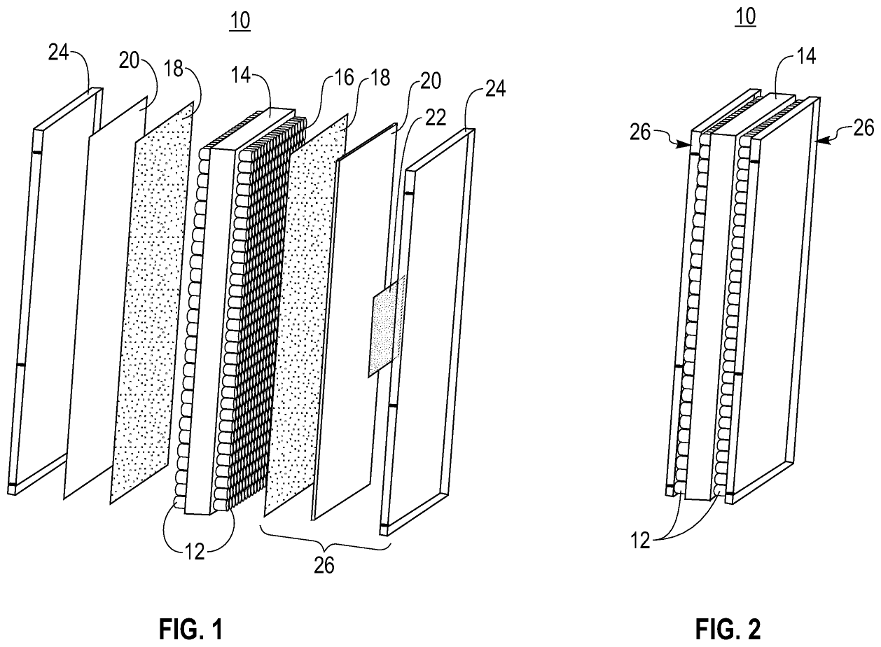

As shown in FIGS. 1 and 2, a battery module 10 includes a plurality of battery cells 12 arranged in a frame 14. The terminals of the cells 12 extend from both sides of the frame 14. The cells 12 are connected together by busbars 16. In one embodiment, the heating assembly includes a thermally conductive pad 18 is placed over the busbars 18 on each side of the module 10. The pads 18 should be electrically insulating. A heat spreader 20 is placed over each thermal pad 18. A heating element 22 is affixed to each heat spreader 20. In one embodiment, covers 24 are fastened to both sides of the battery module 10 to provide an evenly distributed load in order to compress the thermally conductive pads 18 for achieving optimal thermal transfer. The heat spreader 20 conducts heat from the heater 22 to a larger surface area to dissipate the heat to the busbars 16 in contact with the heat spreader 20 through the thermal pad 18. A rectangular sheet of metal to a complex finned copper or aluminum extrusion can be used as a heat spreader 20. In one example, the heat spreader 20 is a simple metal plate in one embodiment, an aluminum or copper plate can be used as an effective heat spreader.

In one embodiment, the thermally conductive pad 18, heat spreader 20 and heating element 22 form a heating assembly 26 for a battery module. The heating element 22 is connected to a voltage source (not shown) to activate the heating element 22, allowing heat to spread across the heat spreader 20, through the thermally conductive pad 18 and into the busbars 16. As busbars 20 are attached to both the positive and negative terminals of the cells 12, the cells 12 are directly heated.

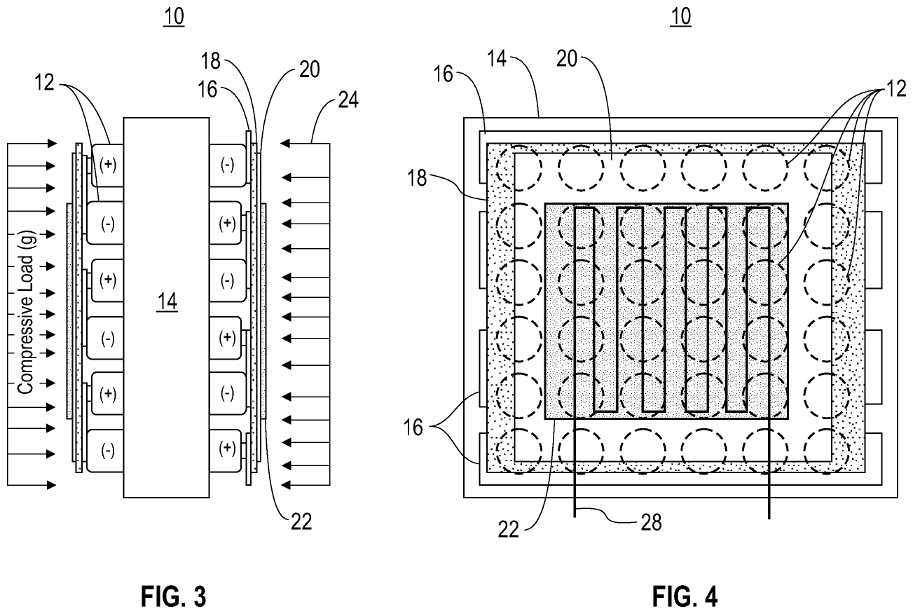

FIGS. 3 and 4 are schematic side and top views of one embodiment of a battery module 10 of the present disclosure. In this arrangement, the positive and negative terminals of adjacent cells 12 are oriented opposite to each other. Individual busbars 16 connect a series of cells 12, as best seen in FIG. 4. In this embodiment, a single thermally conductive pad 18 covers all of the busbars 16 on each side of the frame 14. In other embodiment, multiple pads 18 may be used on each side of the cell frame 14. In addition, in the embodiment of FIGS. 3 and 4, a single heat spreader 20 and a single heater 22 are used for each side of the cell frame 14. In another embodiment, multiple heat spreaders 20 and heaters 22 are used for each side of the cell frame 14.

In one embodiment, a foil heating element 28 is attached to the heater 22. Etched-foil heaters are made from metal foil patterned and etched to create a precise conductive element on its surface. The element's rectangular cross section exposes more of the element's heating surface and puts more of it in contact with the object being heated. Foil heaters may have the heat trace elements spaced close together, as close to each other as 0.004 in. This tight spacing translates into even heat distribution. The element pattern may be created using photolithography.

Foil heaters can be extremely thin. For example, materials such as polyimide can be used to make heaters as thin as 0.005 in., with the foil heating element as thin as 0.0005 in. Being thin lets foil heaters fit in tight spaces, and their flexibility lets them wrap around tight corners and complex shapes. Two of the most commonly used materials for making flexible heaters are polyimide and silicone rubber. The materials serve as both carriers for the foil and as dielectric layers covering the top of the heating element.

Electronic devices can be added to the foil heaters such as thermistors, fuses, and other electrical components. They can be soldered directly to the heater using traditional soldering methods. The result can be a heater with built-in control logic. In one example the heaters are coupled to thermal sensors that proximate the batteries and enable the temperature control. In another embodiment the battery performance is continuously measured and senses when the performance is less than optimal and engages the heater accordingly.

In one embodiment the thermally conductive pad 18 serves as a gap filler. The pad materials may be very soft and conformal, with a dough-like consistency. The very soft thermal gap filler materials are designed to conform and fill in gaps between the heat spreader and the busbars. Thermal gap filler pad 18 is constructed so that when compressed by the cover 25, the pressure drives the material into the microscopic surface texture of the heat spreader 20 and the busbars 16 to maximize thermal conductivity.

For example, the surface of the heat spreader 20 and the busbars 16 typically will not mate perfectly. The air gaps between the surfaces will inhibit good heat transfer. By bridging the voids with a thermally conductive gap filler pad 18, the heat generated by the heat spreader 20 can be transferred, through conduction, to the busbars 16 and the battery terminals of battery cells 12 for heating the batteries.

In one embodiment, the thermal gap filler pads 18 are made from silicone polymer that is combined with a thermal medium, such as ceramic. The silicone and ceramic powders are mixed, cast and cured to a soft, conformal thermal pad material, in sheet form. In one embodiment, the gap filler pads 18 are tacky which also aides in the assembly process. Thermal gap filler pads 18 may range in thickness from 0.020″ to 0.250″ thick. Thermal performance ranges from 1.0 Watt/meter-Kelvin (W/m-K) to 3.0 W/m-K.

The heating assembly 26 of the present disclosure leverages the mechanical arrangement of the cell busbars 16 to efficiently provide cell heating during cold conditions. As noted above, battery cells in a high-power EV/HEV battery pack can be combined in series or parallel to achieve voltage ratings approaching 400 V. Individual cells of about 1.5 to 2.0 V are typical combined using busbars rather than insulated cables. Groups of battery cells are often laser welded to a busbar. A busbar is essentially an electric conductor and ground plane separated by an insulator. It can be fabricated as a single layer component or with multiple layers, including circuit paths for signals as well as for distributing power. As with other basic circuit components, a busbar can be characterized by its resistance, capacitance and inductance, ideally with its electrical contributions distributed as evenly as possible across its length to avoid performance inconsistencies. While the lowest possible resistance and inductance values are to be preferred in a busbar for EV and HEV power distribution, some busbars for that purpose have capacitance added in different ways to increase the charge-carrying capabilities of the power-distribution structure.

With the proper materials, a busbar can assist thermal management along with power distribution in an EV/HEV. A busbar's conductor material and the cross-sectional size of the busbar will determine its current-carrying capacity. Laminated busbars typically consist of copper or aluminum inductors, which may or may not be plated with an additional conductive metal, such as silver or gold. Busbars can be fabricated in a variety of shapes, including flat strips, solid rods and hollow tubes, with flat or hollow forms generally preferred for high-current applications.

The flow of current across any resistive junction in a vehicular power-distribution system can generate heat, including within the battery pack itself. Even low resistance will cause heating effects from large current flow at high enough power levels. Typically, good electrical conductors such as copper are also good thermal conductors. In a busbar, it is the blend of materials and differences in coefficients of thermal expansion (CTEs) for a busbar's composite materials that allows the busbar to be used as part of the battery pack thermal management due to ohmic heating.

In one embodiment, the busbar is made of either copper or aluminum conductors in various thicknesses, such as from 0.5 to 6.0 mm for copper and from 1.0 to 5.0 mm for aluminum. For an EV/HEV application, copper offers superior thermal characteristics to aluminum, with thermal conductivity of 401 W/mK for copper compared to 237 W/mK for aluminum, and thermal expansion of 16.5 ppm/K for copper compared to 23.1 ppm/K for aluminum.

Aluminum busbars are attractive, for EV/HEV applications because they provide reliable electrical performance while helping to save total system weight, since aluminum busbars are typically 50 percent lighter than copper busbars. For equivalent electrical/thermal performance, however, the cross section of an aluminum busbar will be greater than that of a copper busbar with, for example, a 1 mm copper conductor replacing a 2 mm aluminum conductor. For EV/HEV applications, copper busbars offer excellent solutions where space is tight, while aluminum busbars, enable efficient energy distribution with weight savings compared to copper. Aluminum is also less costly than copper.

In addition, while preferred embodiments of the present invention have been described using specific terms, such description is for illustrative purposes only, and it is to be understood that changes and variations may be made without departing from the spirit or scope of the following claims.

What is claimed is:

1. A battery module comprising:
a plurality of battery cells arranged within in a frame, each of the battery cells having terminals;
at least one busbar connecting a plurality of the cell terminals together; and
a heating assembly comprising:
at least one thermally conductive pad covering one or more of the at least one busbar;
a heat spreader plate coupled to the at least one thermally conductive pad; and
at least one heater coupled to the heat spreader plate.

2. The battery module of claim 1, wherein, the at least one thermally conductive pad is electrically non-conductive.

3. The battery module of claim 1, wherein, the at least one busbar is directly attached to the plurality of the cell terminals.

4. The battery module of claim 1, wherein, the at least one heater comprises a foil heating element connected to a voltage source.

5. The battery module of claim 1, comprising at least one busbar connecting a plurality of positive cell terminals together and at least one busbar connecting a plurality of negative cell terminals together.

6. The battery module of claim 1, further comprising a cover plate attached to the frame and configured to compress the heat spreader plate and the at least one thermally conductive pad against the at least one busbar.

7. A battery pack comprising a plurality of battery modules according to claim 1.

8. The battery pack of claim 7, wherein the plurality of battery modules are arranged adjacent to one another and share a heating assembly between the modules.

9. The battery pack of claim 7, wherein the plurality of battery modules are arranged adjacent to one another in a lattice configuration.

10. The battery pack of claim 1, wherein the plurality of battery cells are cylindrically shaped.
